(19) United States
(12) Patent Application Publication
(10) Pub. No.: US 2026/0036762 A1
(43) Pub. Date: Feb. 5, 2026

(54) FIBER OPTIC ADAPTER, PROTECTION UNIT, METHOD FOR MANUFACTURING A FIBER OPTIC ADAPTER

(71) Applicant: Reichle & De-Massari AG, Wetzikon (CH)

(72) Inventors: Tensing GYAGANG, Horgen (CH); Thomas GRAF, Pfäffikon (CH); Claudio STREIFF, Uster (DE)

(21) Appl. No.: 19/285,182

(22) Filed: Jul. 30, 2025

(30) Foreign Application Priority Data
Jul. 30, 2024 (DE) 10 2024 121 724.3

(51) Int. Cl. G02B 6/38

(52) U.S. Cl. CPC G02B 6/3849; G02B 6/3825

(57) ABSTRACT

A fiber optic adapter having at least one basic housing that comprises at least one plug connection opening for an insertion of a plug into the basic housing, and with a protection unit that is arranged on the basic housing and comprises at least one dust protection closure element for a dust-tight closure of the plug connection opening, wherein
the dust protection closure element is realized so as to be spring-elastic and to be self-resetting into a closure position of the dust protection closure element at the plug connection opening.

### CROSS-REFERENCE TO RELATED APPLICATION

This patent application claims priority to and the benefit of German patent application DE 10 2024 121 724.3, filed on Jul. 30, 2024, the contents of which are incorporated herein by reference.

### PRIOR ART

The invention concerns a fiber optic adapter, a protection unit and a method for manufacturing a fiber optic adapter.

Fiber optic adapters with a dust cap, which close the plug connection opening as an easier-to-remove plug, are already known from the prior art.

Furthermore, fiber optic adapters with a protection unit, which have a dust protection closure element designed as a closable hard flap, are already known from the prior art.

The objective of the invention is in particular to provide a generic fiber optic adapter with improved properties regarding reliability. The objective is achieved according to the invention.

### ADVANTAGES OF THE INVENTION

The invention is based on a fiber optic adapter with at least one basic housing that comprises at least one plug connection opening for an insertion of a plug into the basic housing, and with a protection unit that is arranged on the basic housing and comprises at least one dust protection closure element for a dust-tight closure of the plug connection opening.

It is proposed that the dust protection closure element is realized so as to be spring-elastic and to be self-resetting into a closure position of the dust protection closure element at the plug connection opening.

The implementation according to the invention advantageously allows providing a fiber optic adapter with increased reliability since advantageously, if there is no plug in the plug connection opening that is configured for the coupling of an optical plug, an accumulation of dust and/or further foreign bodies can be prevented. Furthermore, a performance of the fiber optic adapter can advantageously be optimized since it is possible to prevent impairment, due to dust and/or foreign bodies, of a signal connection between two plugs via the adapter. Furthermore, a durability of the fiber optic adapter can advantageously be increased. It is moreover advantageously possible to augment operator-friendliness, in particular due to the spring elasticity of the dust protection closure element providing a self-resetting, so that an operator closes the plug connection opening in a dust-tight manner without an effort of his own. This furthermore advantageously increases operational reliability of the fiber optic adapter as a possible faulty operation of the dust protection closure element is reduced.

The fiber optic adapter preferably has at least one, particularly preferably at least two opposite-situated plug connection openings, which is/are in particular configured to receive a plug, particularly preferably at least two opposite-situated plugs. The fiber optic adapter is preferably configured for a coupling of at least two opposite-situated plugs, preferably in such a way that an optical signal can be transmitted from the at least one plug to the at least one further plug. Preferably the fiber optic adapter, in particular the plug connection opening, is configured for plug connections with fiber optic plugs, particularly preferably LC plugs, which in particular have a small form factor. In principle, an implementation of the fiber optic adapter, in particular the plug connection opening, for receiving further plugs, in particular FC plugs, SC plugs, FDI plugs, ST plugs or further plugs deemed expedient by someone skilled in the art, is conceivable. In particular, the fiber optic adapter is configured for a connection between optical conductors of a fiber optic communication system, wherein in particular ends of optical conductors, in particular of fiber optic cables, preferably of single-mode fiber cables and/or multi-mode fiber cables, of two opposite-situated plugs are connected, preferably in such a way that an optical signal can be transmitted between the optical conductors. The fiber optic adapter is preferably configured for insertion into a patch field and/or a patch panel. In particular, the fiber optic adapter is part of an adapter system, wherein the fiber optic adapter is preferably arranged in the patch field and/or the patch panel. Preferably the fiber optic adapter, in particular the basic housing, is at least substantially made of plastic, in particular as an injection-molded part. Alternatively or additionally, the fiber optic adapter, in particular the basic housing, is at least partially made of stainless steel, aluminum, ceramic, a composite material and/or of a further material deemed expedient by someone skilled in the art.

The protection unit and the dust protection closure element are configured for a dust-tight closure of the plug connection opening, wherein in particular the dust protection closure element in the closure position at least substantially prevents an entry of foreign bodies, in particular dust, dirt or other environmental contaminants. In particular, the dust protection closure element closes the plug connection opening at least substantially completely, such that an entry of foreign bodies into the inner region of the fiber optic adapter is prevented from all sides, in particular from the plug connection opening. Preferably, according to DIN EN 60529 (VDE 0470-1):2014-09, in particular at least with regard to the protection against foreign bodies, the fiber optic adapter in the closure position of the dust protection closure element preferably has at least class IP3X, advantageously at least class IP4X, particularly preferentially at least class IP5X and especially advantageously at least class IP6X.

Particularly preferentially, the protection unit, in particular the dust protection closure element, is arranged on an inner side of the plug connection opening, in particular within the basic housing. Preferably, during an insertion the plug is situated initially in the plug connection opening and is subsequently in contact with the protection unit, in particular the dust protection closure element. Preferably, the dust protection closure element is realized so as to be spring-elastic, in particular automatically, into an opening position of the dust protection closure element. In particular, the dust protection closure element is realized in such a way that it is deformable upon application of an external force, preferably upon insertion of the plug or of another connection element, wherein in particular a shape of the dust protection element, which extends over the plug connection opening, changes. Preferably, the dust protection closure element is configured, by way of its spring elasticity, in particular its deformability, to provide access into the inner region of the fiber optic adapter, in particular the inner region of the basic housing, preferably for the plug or for a further connection element. In particular, the dust protection closure element is configured, upon insertion of the plug, to move from the closure position to an opening position in which the plug is connected with the fiber optic adapter.

Preferably, the dust protection closure element is configured, if there is no external force, in particular upon removal of the external force, preferably upon removal of the plug or of a further connection element from the inner region of the fiber optic adapter, in particular of the basic housing, to return into the closure position of the dust protection closure element in a self-resetting manner, in particular automatically, preferably due to the spring elasticity of the dust protection closure element. Particularly preferentially, the dust protection closure element is realized so as to be permanently elastic. In this way, a repeated application of the dust protection closure element can advantageously be provided at least substantially without wear or loss of sealing capability.

Particularly preferentially, the dust protection closure element has spring-elastic material properties which provide the self-resetting. Preferably, the dust protection closure element is made of steel and/or rubber and/or of a further material with spring-elastic properties. Particularly preferentially, in particular due to its spring elasticity, the dust protection closure element can be bent open from a closure position, preferably in a flap-like manner, starting from an edge of the plug connection opening. Preferably, the dust protection closure element has a pivot axis which is—preferably when the fiber optic adapter is viewed along a plug-in axis at the level of the main edge of the plug connection opening—at least substantially parallel to a main edge of the plug connection opening, and in particular perpendicular to the plug-in axis. Particularly preferentially, the dust protection closure element has only one pivot axis. In particular, the pivot axis is at a vertical wall of the fiber optic adapter, which is in particular parallel to a vertical edge of the plug. Preferably, in the closure position, the dust protection closure element extends, in particular in a one-part implementation, at least substantially completely, over the plug connection opening, in particular completely over a horizontal and/or a vertical of the plug connection opening, preferably when viewed along the plug-in axis of the plug connection opening. Particularly preferentially, a pivoting end of the dust protection closure element, preferably forming a vertical end region, is arranged—at least in the closure position—so as to bear against a wall of the basic housing, in particular so as to bear at least substantially against a wall opposite the vertical wall.

Here and in the following, “configured” is to mean specially programmed, designed and/or equipped. By an object being configured for a specific function is to be understood that the object fulfils and/or carries out this specific function in at least one application state and/or operation state.

Furthermore, it is proposed that the protection unit comprises at least one laser protection element, wherein the laser protection element is realized integrally with the dust protection closure element. In this way, it is advantageously possible to provide laser protection for an operator and in particular operator to increase reliability. It is herein advantageously possible to prevent the emergence of light from an already connected plug in a further plug connection opening of the fiber optic adapter, which would in particular damage the eyes of the operator. It is moreover advantageously possible to integrate laser protection and dust protection in the fiber optic adapter in a manner that is as space-saving as possible. In particular, the laser protection element is realized so as to be spring-elastic and to be self-resetting into a closure position of the laser protection element at the plug connection opening. “Integrally” is in particular to mean connected at least by material bond, for example by a welding process, a gluing process, an injection-molding process and/or another process that is deemed expedient by someone skilled in the art, and/or particularly advantageously formed in one piece, such as for example by a production from a casting and/or by a production in a single-component or multi-component injection-molding procedure, and advantageously from a single blank. In particular, the dust protection closure element at least substantially also forms the laser protection element. In particular, the dust protection closure element differs from the laser protection element only in its functions. In particular, the laser protection element is configured to prevent an emergence of optical signals, in particular light beams, from the inner region of the fiber optic adapter, in particular of the basic housing, preferably of a further plug that is connected to the fiber optic adapter. Preferably, the laser protection element is made of a material that is non-transparent to laser light at wavelengths that are to be expected, said material reflecting and/or absorbing light within the basic housing in order to provide laser protection properties.

It is further proposed that the dust protection closure element is elastically pretensioned in the closure position. This advantageously allows further improving a dust-tight closure of the plug connection. It is moreover advantageously possible to improve laser protection properties. In particular, in the closure position the laser protection element is elastically pretensioned. The dust protection closure element being “pretensioned” is in particular to mean that in the closure position the dust protection closure element continuously exerts force on an abutment surface of the basic housing, wherein—in particular upon a theoretical removal of the abutment surface—the dust protection closure element would move beyond a closure position in the direction of a plug entry of the plug connection opening. In particular, in an assembled state at least a portion of the pretensioned dust protection closure element is deflected from a force-free base position which the portion would assume in an unassembled state. Preferably, the closure position of the dust protection closure element and/or of the laser protection element is defined by the abutment surfaces, from which the dust protection closure element and/or the laser protection closure element are/is preferably realized so as to be spring-elastically self-resetting upon insertion of a plug into the plug connection openings.

It is moreover proposed that the protection unit is realized as a monolithic component, in particular as a bent sheet metal part or as a punched and bent sheet metal part. In this way, laser protection and dust protection can advantageously be arranged in the fiber optic adapter, in particular in the basic housing, in a manner that is as space-saving as possible. Furthermore, a self-resetting of the dust protection closure element and/or of the laser protection element can be provided in a favorably simple manner. A “monolithic component” is in particular to mean a component having a uniform, continuous structure, which is in particular formed free of joinings or connections of separate components. In particular, the protection unit is realized as a bent sheet metal part, the protection unit consisting of a single sheet, wherein preferably the shape of the protection unit is bent into the specific shape by a bending process. Preferably, the monolithic component, in particular the bent sheet metal part, forms the dust protection closure element and/or the laser protection element, wherein preferably the spring elasticity of the dust protection closure element and/or of the laser protection element is provided by the material properties of the monolithic component, in particular of the bent sheet metal part. Preferably, the protection unit, in particular the dust protection closure element and/or the laser protection element, is configured to enable an insertion of the plug by the bending of the bent sheet metal part.

It is also proposed that the fiber optic adapter comprises a guide unit for guiding the plug during an insertion of the plug into the basic housing, with at least one horizontal guide element formed by the dust protection closure element. This advantageously allows providing a favorably stable insertion, in particular with a protection unit being arranged within the basic housing. Moreover, in this way a deflection of the plug to the left or to the right can advantageously be effectively prevented. Preferably, the horizontal guide element and the dust protection closure element and/or the laser protection element are identical, wherein the horizontal guide element and the dust protection closure element and/or the laser protection element preferably differ only function-wise. Preferably, the horizontal guide element is configured to, in particular continuously, bend during the insertion of the plug, and preferably to extend along a basic-housing wall. Preferably the basic housing, in particular a wall along which the horizontal guide element can be bent continuously, comprises guide elements, for example bulges and/or curves, so that the horizontal guide element is configured, during the insertion of the plug, to prevent a displacement of the plug perpendicular to the plug-in axis in the horizontal plane. In particular, the horizontal guide element is realized for bending over the guide elements during the insertion of the plug, and thus preferably to provide a guidance of the plug. In particular, the horizontal guide element is configured to clamp the plug together with the guide elements in a horizontal plane of the basic housing.

Preferably, a horizontal element, in particular a horizontal plane and/or a horizontal axis, in particular if not further defined, is an element, a plane and/or an axis which is at least approximately parallel to a main extension plane of the fiber optic adapter, wherein the main extension plane is in particular parallel to a largest side surface of a smallest imaginary cuboid just still completely enclosing the fiber optic adapter, and in particular extends through the center point of the cuboid. Particularly preferentially, a horizontal element, a horizontal plane and/or a horizontal axis is at least approximately perpendicular to a pivot axis of the dust protection closure element. Preferably, a vertical element, in particular a vertical plane and/or a vertical axis, in particular if not further defined, is an element, a plane and/or an axis which is at least approximately perpendicular to a main extension plane of the fiber optic adapter. Particularly preferentially, a vertical element, a vertical plane and/or a vertical axis is at least approximately parallel to the pivot axis of the dust protection closure element.

It is moreover proposed that the basic housing comprises at least one further plug connection opening, wherein the further plug connection opening can be closed in a dust-tight manner by means of a further dust protection closure element of the protection unit. This advantageously allows providing a dust-tight closure for at least two adjacently arranged plugs or for a duplex plug. Particularly preferentially, the fiber optic adapter is embodied as a duplex adapter, wherein preferably the two plug connection openings are arranged side by side in the basic housing on one side, providing a receptacle of standardized duplex plugs, for example of a standardized duplex plug of the “LC” type. In particular, the basic housing has a partition wall between the plug connection opening and the further plug connection opening. Preferably the partition wall comprises the guide elements for the horizontal guide element. In particular, the pivot axis of the dust protection closure element and/or of the laser protection element is on that side of the plug connection opening which forms the partition wall, and preferably the pivot axis is at least approximately in a main extension plane formed by the partition wall. Preferably the further plug connection opening and/or the further dust protection closure element are/is realized identically to the plug connection opening and/or the dust protection closure element, and preferably comprise/s all elements thereof, wherein preferably the further plug connection opening and/or the further dust protection closure element are/is realized mirror-symmetrically to the plug connection opening and/or the dust protection closure element with respect to a mirror plane implemented by the main extension plane of the partition wall. In particular, the protection unit, as a monolithic component, in particular as a bent sheet metal part, forms the dust protection closure element and the further dust protection closure element, and preferably forms the laser protection element and a further laser protection element. Preferably the protection unit, in particular a cross-section of the protection unit, is realized at least approximately in a V-shaped fashion, wherein the dust protection closure element and the further dust protection closure element preferably in each case form an arm of the V-shape, said arms in particular projecting—convexly towards each other starting from the partition wall—over the plug connection opening.

In particular, the protection unit comprises a fastening element, which is preferably connected integrally with the dust protection closure element and the further dust protection closure element. Preferably the fastening element is configured to fasten the protection unit, in particular the dust protection closure element and/or the further dust protection closure element, in the basic housing. Particularly preferentially, the dust protection closure element, preferably the fastening element of the protection unit which merges directly into the dust protection closure element, is realized so as to be folded around a proximal end edge of the partition wall and to cover the plug connection openings, wherein at least the partition wall is preferably configured to absorb forces acting on the dust protection closure element, in particular by a plug and/or by the elastic pretensioning in the closure position.

Beyond this, the dust protection closure element preferably has a shape, in particular a thickness and/or height, that provides an at least approximately uniformly distributed plug-in force for a pivoting process of the dust protection closure element over an entire plug-in path of the plug. This advantageously allows improving a plug-in behavior and thus operator-friendliness. In particular, viewed along the horizontal extent of the dust protection closure element, in particular starting from the partition wall, the dust protection closure element, in particular the cross-section of the dust protection closure element, has at least one curved part and at least one linear part, preferably at least two curved parts and at least two, particularly preferentially at least three, linear parts, wherein at least the first linear part is preferably realized so as to bear against the partition wall, and wherein in particular the first curved part is realized at least substantially starting from the partition wall, and the second curved part is realized at least approximately in a middle region of the plug connection opening, in particular in a middle region of the horizontal extent of the dust protection closure element. Preferably, during a plug-in process, the at least one curved part is configured to provide a bending-open of the dust protection closure element, wherein in particular the at least one curved part, preferably the entire dust protection closure element, is at least approximately linear when a plug is located completely in the plug connection opening.

A central angle of the at least one curved part, in particular of the first curved part, in particular starting from a curved-part tangent that is at least approximately parallel to the plug-in axis, is in the closure position of the dust protection closure element in particular between 90° and 10°, preferably between 75° and 25°, advantageously between 60° and 35°, particularly preferentially between 50° and 40° and especially advantageously at least approximately 45°, and in particular a central angle of the second curved part is in particular between 80° and 5°, preferably between 70° and 20°, advantageously between 50° and 30° and particularly preferentially between 40° and 35°. The at least one curved part extends over a length of the dust protection closure element that is in particular between 40% and 1%, preferably between 30% and 5% and particularly preferentially between 20% and 10%. With the at least two curved parts and the at least two linear parts, a length of the dust protection closure element can advantageously be reduced, in particular in comparison to a purely arc-shaped dust protection closure element.

It is moreover proposed that the dust protection closure element has a shape which enables an insertion of the plug into the basic housing that is contact-free with respect to a ferrule of the plug and to the dust protection closure element. This advantageously allows providing a stable positioning of the ferrule during the plug-in process of the plug, as a result of which advantageously an improvement of reliability and precision of the connection is achievable. Such stability furthermore advantageously reduces the risk of mechanical damages both to the ferrule and to the adapter, which will advantageously result in a longer service life and lower maintenance costs. Particularly preferentially, the at least one curved part and the at least one linear part of the dust protection closure element enable the contact-free insertion of the plug with respect to the ferrule. Preferably, during the plug-in process the dust protection closure element is in contact only with an edge of the plug, wherein preferably the horizontal guide element guides the plug horizontally via the edge.

It is further proposed that the fiber optic adapter comprises the guide unit for guiding the plug during an insertion of the plug into the basic housing, wherein the basic housing comprises a vertical guiding surface which has at least one chamfer arranged on the opening side. This advantageously allows ensuring standard-conform optimal guidance over the entire plug-in path of the plug, advantageously although the pivotable dust protection closure element is arranged within the basic housing. Furthermore, advantageously by means of the chamfers, the plug is effectively prevented from getting stuck in the case of inadvertently oblique insertion. In particular, the vertical guiding surface is configured to form a support surface for the plug, in particular along the plug-in path of the plug. Preferably, the vertical guiding surface is configured to guide the plug on that side of the basic housing which forms a latching receptacle for a latching element, in particular a latching lug system, of the plug, wherein the vertical guiding surface is preferably realized differently from a horizontal outer wall of the basic housing. In particular, the vertical guiding surface, in particular exclusively, adjoins a vertical outer wall of the basic housing and preferably only forms a support surface for an edge region of the plug.

The vertical guiding surface extends over in particular at least 50%, preferably at least 60% and particularly preferentially at least 75% of a length of the basic housing that is parallel to a plug-in path. In this way, it is advantageously possible to provide standardized plug guidance over a longer distance in an interrupted manner, which advantageously results in fewer malfunctions and prevents total failure of the connection. In particular, the vertical guiding surface comprises at least one interruption, preferably for the pivoting region of the dust protection closure element, wherein next to the interruption, the vertical guiding surface in each case has a further chamfer arranged on the opening side.

It is moreover proposed that, viewed in the plug-in direction, a base frame of the basic housing delimits the plug connection opening from four sides. This advantageously allows improving the stability of the plug in the fiber optic adapter, as a result of which advantageously IL problems in the coupling, in particular in the case of mechanical load, can be reduced. Preferably, the basic housing is realized such that the base frame is arranged at the plug entry of the basic housing, wherein the base frame, viewed in the plug-in direction, delimits the plug from four sides, in particular supports the plug in the plug entry in all directions perpendicular to the plug-in axis. In this context, “delimited” is in particular to mean that, during the plug-in process and in a completely connected state, the base frame is at least section-wise in direct contact with the plug on all four sides. Preferably the base frame extends least over a subregion of the plug connection opening, in particular of the plug-in path, in particular over at least 5%, preferably at least 10%, advantageously at least 15% and particularly preferentially at least 20% of the plug connection opening, in particular of the plug-in path, wherein the base frame preferably is in continuous contact with all four sides of the plug.

Furthermore, it is proposed that the basic housing forms a vertical abutment surface for the vertical end region of the dust protection closure element in the closure position, which vertical abutment surface in particular extends over an at least substantially entire vertical extent of the dust protection closure element. This advantageously allows further optimizing a dust-tight closure of the dust protection closure element. Particularly preferentially, the vertical abutment surface is configured to close the inner region with the vertical end region of the dust protection closure element, at least with respect to the vertical outer wall of the basic housing, in particular regarding an entry of dust. In particular, the vertical end region is an end region of the dust protection closure element which has a free end. By an “at least substantially entire vertical extent” is to be understood that the vertical abutment surface extends over in particular at least 80%, preferably at least 90%, advantageously at least 95% and particularly preferentially at least 98% of the dust protection closure element and in particular of the vertical extent of the inner region of the basic housing. Preferably, the vertical abutment surface is configured to provide a counterforce for the elastic pretensioning of the dust protection closure element in the closure position. Particularly preferentially, the vertical outer wall of the basic housing at least partially forms the vertical abutment surface. In particular, at least the vertical abutment surface creates the interruption of the vertical guiding surface.

It is further proposed that in the closure position the basic housing forms at least one horizontal abutment surface for a horizontal end region of the dust protection closure element. This advantageously allows further optimizing a dust-tight closure of the dust protection closure element. Particularly preferentially, the horizontal abutment surface is configured to close the inner region with the horizontal end region, at least with respect to the horizontal outer wall of the basic housing, in particular regarding the entry of dust. In particular, the horizontal end region of the dust protection closure element is a lateral region of the dust protection closure element, which is different from the end region comprising the free end of the dust protection closure element. Preferably, at least one of the horizontal outer walls of the basic housing comprises the horizontal abutment surface. Particularly preferentially, both horizontal outer walls of the basic housing each comprise a horizontal abutment surface. Particularly preferentially, at least one horizontal abutment surface extends at least substantially over an entire horizontal extent of the dust protection closure element, wherein the horizontal abutment surface extends over in particular at least 80%, preferably at least 90%, advantageously at least 95% and particularly preferentially at least 98% of the dust protection closure element and in particular of the horizontal extent of the inner region of the basic housing.

It is moreover proposed that the vertical abutment surface is configured, together with horizontal abutment surfaces, to create an at least largely circumferential sealing in the closure position of the dust protection closure element. In this way it is advantageously possible to at least substantially prevent from all sides an entry of foreign bodies into the inner region of the basic housing. By a “largely circumferential sealing” is in particular to be understood that in the closure position of the dust protection closure element in particular at least 70%, preferably at least 80%, advantageously 90% and particularly preferentially at least 95% of the inner region are sealed by the horizontal abutment surfaces and the vertical abutment surface, and/or that the horizontal abutment surfaces and the vertical abutment surface are in direct contact with the end region of the dust protection closure element. Preferably, on the side of the partition wall the plug connection opening is sealed by the fastening element of the protection unit, in particular by the bending of the fastening region around the end region of the partition wall.

Beyond this it is proposed that the basic housing forms at least one recess or depression, which implements the at least one horizontal abutment surface and/or the vertical abutment surface. In this way it is advantageously possible to provide a favorably space-saving sealing within the basic housing. Furthermore, it is advantageously possible to improve stability during the insertion of the plug. Preferably, the vertical abutment surface is realized as a depression, in particular in the vertical outer wall of the basic housing. Preferably, the depression that forms the vertical abutment surface implements the interruption of the vertical guiding surface. Preferably, at least the horizontal abutment surface is realized as a depression, in particular in the horizontal outer wall of the basic housing, preferably on the side of the basic housing that forms the latching receptacle. Particularly preferentially, the depression for the horizontal abutment surface extends over the entire pivoting region of the dust protection closure element, in particular such that the horizontal end region of the dust protection closure element is arranged in the depression over the entire pivoting region from the closure position to the opening position. Preferably, the depression for the horizontal abutment surface is realized at least approximately in the shape of a half gingko leaf, wherein preferably the depression of the horizontal abutment surface of the dust protection closure element and a further depression of a further horizontal abutment surface of the further dust protection closure element are realized together so as to be at least approximately in the shape of a gingko leaf. Preferably, at least the further horizontal abutment surface is realized as the recess, in particular in the horizontal outer wall of the basic housing, preferably on a side opposite the side of the latching receptacle. Particularly preferentially, the dust protection closure element comprises an abutment portion for an abutment with the horizontal abutment surface formed by the recess, wherein the abutment portion is realized within the basic housing as a bulge, in particular starting from a horizontal edge of the dust protection closure element, said bulge in particular extending beyond the inner region of the basic housing. Preferably the abutment portion of the dust protection closure element is arranged in the recess over the entire pivoting region of the dust protection closure element from the closure position to the opening position. Preferably the fiber optic adapter comprises a clip-on frame, which is configured at least to close the recess of the basic housing.

It is also proposed that the dust protection closure element comprises at least one glide shoe. This advantageously allows optimizing wear and thus a service life of the basic housing. Furthermore, it is advantageously possible to optimize a gliding capability of the dust protection closure element, in particular in the depression, such that the plug-in force during insertion of the plug can be further minimized. Preferably, the glide shoe is configured for a low-friction interaction between the dust protection closure element that is realized as a bent sheet metal part and the horizontal outer wall of the inner region of the basic housing. Particularly preferably, the glide shoe is formed from the bent sheet metal part of the dust protection closure element. In particular, the glide shoe is arranged at a horizontal end region of the dust protection closure element, in particular in the direction of the inner region, opposite the horizontal abutment surface. Particularly preferentially, the glide shoe is realized integrally with the dust protection closure element. Preferably, the glide shoe is arranged in a vertical end region of the dust protection closure element. Particularly preferentially, the glide shoe is configured to glide in the depression of the horizontal abutment surface. Preferably, the glide shoe is an inwards-angled sheet metal part of the dust protection closure element, wherein a surface of the glide shoe that is different from an edge is configured for the gliding. Preferably, the dust protection closure element comprises at least one further glide shoe, which is configured to glide on the further horizontal outer wall of the basic housing.

In a further implementation of the invention, it is proposed that the dust protection closure element comprises at least two dust protection closure parts, which preferably respectively extend at least substantially completely over one of the plug connection openings, in particular extending completely over a vertical and a horizontal of the plug connection opening. This advantageously allows further increasing an abutment pressure of the dust protection closure element against the vertical outer wall, and advantageously increasing dust-tightness. It is moreover advantageously possible, due to the increased abutment pressure, to dispense with an abutment surface that is realized as a depression in the vertical outer wall, or to further increase a dust-tightness a combination of this dust protection closure element with the abutment surface that is realized as a depression. In particular, the dust protection closure element with the two dust protection closure parts is realized at least section-wise, preferably completely, in a double-walled implementation. Particularly preferentially, the entry-side dust protection closure part and/or the inner-side dust protection closure part are/is realized at least substantially, in particular at least by 50%, preferably at least by 75%, advantageously at least by 90%, particularly preferentially at least by 95% and particularly advantageously completely, in an arc-shape, preferably with an at least substantially constant curvature radius. Preferably, the dust protection closure element has a U-bend, which in particular connects the two dust protection closure parts, in particular via a continuous material connection, and is in particular configured to provide an abutment with the vertical outer wall. Particularly preferentially, the two dust protection closure parts are realized so as to diverge, starting from the U-bend, in particular extending over the plug connection opening, wherein the dust protection closure element has an angle between the dust protection closure parts of at most 90°, preferably at most 60°, advantageously at most 45°, particularly preferentially at most 30° and particularly advantageously at most 15°. Preferably, the entry-side dust protection closure part is connected to the fastening element of the protection unit. Preferably, the inner-side dust protection closure part comprises a gliding portion, which bears glidingly against the partition wall and is preferably realized so as to be guidable on the partition wall when the dust protection closure element is opened. Particularly preferentially, the inner-side dust protection closure part, in particular for providing an abutment pressure when the dust protection closure element, in particular the U-bend, abuts against the vertical outer wall, is pretensioned between the partition wall and the vertical outer wall, preferably by the arc shape. Particularly preferentially, the partition wall of the basic housing has a guiding surface along which the gliding portion of the dust protection closure element glides. Particularly preferentially, the partition wall, in particular in a region of the guiding surface, is realized so as to be at least partially convex, in particular tapering. Preferably, the part of the plug connection opening between the inner-side dust protection closure part and the plug abutment is realized so as to be sloping, in particular so that the dust protection closure element runs freely, in particular does not get stuck, when actuated.

Furthermore, the invention relates to the protection unit for a fiber optic adapter. This advantageously allows providing a protection unit for a fiber optic adapter with increased reliability since, if there is no plug in the plug connection opening that is configured for the coupling of the optical plug, an accumulation of dust and/or further foreign bodies can advantageously be prevented. It is moreover advantageously possible to increase operator-friendliness, in particular due to the spring elasticity of a portion of the protection unit, in particular of the dust protection closure element and/or of the laser protection element, which provides a self-resetting, so that an operator closes the plug connection opening in a dust-tight manner without an effort of his own. Furthermore, advantageously a protection unit can be provided which is realized such that it can be exchanged and maintenance as flexibly as possible. Preferably, the protection unit is the monolithic component, in particular the bent sheet metal part, which—in particular integrally—comprises the dust protection closure element and preferably the laser protection element. Preferably, the protection unit is configured for a fiber optic adapter, wherein the protection unit is realized such that it is mountable in the basic housing of the fiber optic adapter. In particular, the protection unit comprises the fastening element which is configured for the coupling with a counterpart of a basic housing of a fiber optic adapter. Preferably, the protection unit further comprises the horizontal guide element of the guide unit.

Beyond this, the invention is based on a method for manufacturing the fiber optic adapter. According to the invention, the fiber optic adapter is assembled on one side. This advantageously allows manufacturing of a fiber optic adapter with increased reliability since, if there is no plug in the plug connection opening that is configured for the coupling of the optical plug, it is advantageously possible to prevent an accumulation of dust and/or of further foreign bodies. Moreover, the assembly process and/or the maintenance of the fiber optic adapter can advantageously be simplified and the risk of assembly errors can be reduced since access is required only from one side. Preferably, all individual parts of the fiber optic adapter are assembled, in particular inserted into a base body of the basic housing, on one side vertically, in particular with respect to the plug-in axis. Preferably, the fiber optic adapter comprises a mounting opening, provided in particular by a removal of the cover of the basic housing, wherein the cover in particular constitutes one of the horizontal outer walls. Preferably, in at least one first method step, the dust protection closure element is inserted into the basic housing. In at least one further method step, a cover of the basic housing is mounted on the base body of the basic housing for closing the basic housing. In at least one further method step, the clip-on frame is guided onto the basic housing, in particular via the cover.

Furthermore, a system with at least two fiber optic adapters, preferably at least the fiber optic adapter with the dust protection closure element, in particular the protection unit, and with a coupling unit which is configured to connect the at least two fiber optic adapters to one another, is proposed. In particular, a clip-on frame at least partially forms the coupling unit. Preferably, the clip-on frame comprises at least two receptacles for a fixing of the at least two fiber optic adapters. In particular, the clip-on frame together encompasses the at least two fiber optic adapters, wherein the clip-on frame, in particular the basic housing of the fiber optic adapters, completely engages around the fiber optic adapters, preferably in such a way that two side surfaces of the clip-on frame, which are in particular respectively in contact with one of the fiber optic adapters, are parallel to each other. Particularly preferably, the coupling unit comprises a coupling element which connects the at least two fiber optic adapters to one another, in particular by a form fit Preferably, the at least two fiber optic adapters have at least one recess for a form-fit engagement of the coupling element. In particular, the coupling element extends from one fiber optic adapter to the at least one further fiber optic adapter. In particular, the coupling element is realized at least substantially in a rod shape, in particular at least approximately in a bone shape, the coupling element having side edges which extend longitudinally and are at least substantially parallel at least section-wise. Particularly preferentially, the coupling element comprises at least one transverse beam, which is in particular realized so as to be perpendicular to a longitudinal axis of the coupling element, in particular perpendicular to the at least substantially parallel side edges. In particular, the coupling element comprises at least one, preferably only one, transverse beam for each fiber optic adapter.

When the fiber optic adapter has been produced, preferably the plug is guided into the plug connection opening during a plug-in process. During the plug-in process, preferably the dust protection closure element is bent open, in particular until it bears at least approximately linearly against the partition wall of the basic housing. During the plug-in process, preferably the dust protection closure element, in particular the horizontal guide element, extends over the guide elements of the basic housing and a horizontal guidance is provided. During the plug-in process, preferably the vertical end region of the dust protection closure element is guided out of the depression that forms the vertical abutment surface. During the plug-in process, preferably the horizontal end region of the dust protection closure element is guided in the depression of the horizontal abutment surface.

Herein the fiber optic adapter according to the invention, the protection unit according to the invention and the method according to the invention shall not be restricted to the application and implementation described above. In particular, in order to fulfil a functionality that is described here, the fiber optic adapter according to the invention, the protection unit according to the invention and the method according to the invention may have a number of individual elements, components, units and method steps that differs from a number given here.

### DRAWINGS

Further advantages will become apparent from the following description of the drawings. Four exemplary embodiments of the invention are illustrated in the drawings. The drawings, the description and the claims contain a plurality of features in combination. Someone skilled in the art will purposefully also consider the features individually and will find further expedient combinations.

In the drawings:

FIG. 1 shows an exploded illustration of a fiber optic adapter, with a basic housing and with at least one protection unit,

FIG. 2 shows a plan view of the fiber optic adapter, open at the top, with the basic housing, with the protection unit and with a plug that is partially inserted in a plug connection opening of the basic housing,

FIG. 3 shows a sectional view of a base body of the basic housing,

FIG. 4 shows a sectional view of the fiber optic adapter and of the plug, the plug being arranged completely in the plug connection opening,

FIG. 5 shows the protection unit, at least with a dust protection closure element, a laser protection element and a fastening element,

FIG. 6 shows an exploded illustration of an alternative fiber optic adapter, with a basic housing and with at least one protection unit, the fiber optic adapter being realized so as to be mountable on one side,

FIG. 7 shows a plan view of the alternative fiber optic adapter, open at the top, with the basic housing and with the protection unit mounted therein,

FIG. 8 shows a schematic illustration of a method for an assembly of the fiber optic adapter,

FIG. 9 shows an exploded illustration of a further alternative fiber optic adapter, with a basic housing and with at least one protection unit, the basic housing comprising recesses at least for a part of the protection unit,

FIG. 10 shows a sectional view of the further alternative fiber optic adapter, with the basic housing and with the protection unit mounted therein,

FIG. 11 shows a sectional view of a further alternative fiber optic adapter, with a portion of a basic housing and with a protection unit, the protection unit comprising at least one glide shoe,

FIG. 12 shows an axonometric view of a further alternative fiber optic adapter, open at the top, with a basic housing and with a protection unit, the protection unit comprising an at least substantially double-walled dust protection closure element,

FIG. 13 shows a sectional plan view of the further alternative fiber optic adapter with the protection unit, and

FIG. 14 shows a system with a plurality of fiber optic adapters and with a coupling unit.

### DESCRIPTION OF THE EXEMPLARY EMBODIMENTS

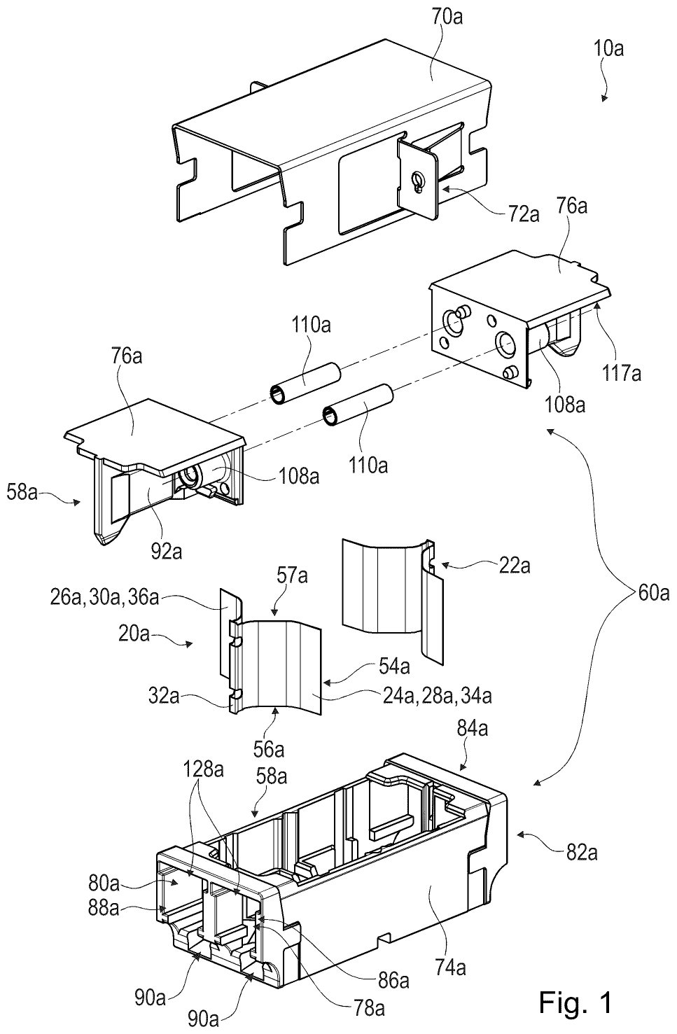

FIG. 1 shows an exploded illustration of a fiber optic adapter 10a. The fiber optic adapter 10a comprises at least one basic housing 60a. The basic housing 60a comprises at least one plug connection opening 78a for an insertion of a plug 12a into the basic housing 60a. The fiber optic adapter 10a comprises at least two plug connection openings 78a, 82a aligned with each other. Respectively one plug 12a of the “LC” type can be inserted into the plug connection opening 78a and the opposite-situated plug connection opening 82a. The opposite-situated plug connection openings 78a, 82a are realized in such a way that optical fibers 182a guided in the plugs 12a are in a communicative connection with each other in a state in which they are completely connected with the fiber optic adapter 10a. The basic housing 60a comprises at least one further plug connection opening 80a. The basic housing 60a comprises at least one plug connection opening 84a that is situated opposite the further plug connection opening 80a. The further plug connection opening 80a is identical to the plug connection opening 78a. The basic housing 60a is in the further plug connection opening 80a realized in a same manner as in the plug connection opening 78a. The plug connection openings 78a, 80a are arranged side by side on one side of the basic housing 60a. The basic housing 60a comprises a partition wall 114a between the plug connection opening 78a and the further plug connection opening 80a. The fiber optic adapter 10a is embodied as a duplex adapter 10a. The plug connection openings 78a, 80a, 82a, 84a are configured for receiving standardized duplex plugs 12a of the “LC” type. The fiber optic adapter 10a is configured for receiving two mutually aligned duplex plugs 12a. The plug connection opening 78a and the further plug connection opening 80a in each case define a receiving space for the plug 12a from a plug entry 86a and a further plug entry 88a to a plug abutment 120a.

The basic housing 60a has a base body 74a. For an assembly of the fiber optic adapter 10a, the base body 74a has a mounting opening which differs from the plug connection opening 78a. The basic housing 60a comprises at least one cover 76a. The cover 76a is configured for a closure of the basic housing 60a. The cover 76a comprises at least one conductor guide 108a. The conductor guide 108a is configured to receive at least one conductor guide sleeve 110a, which is configured to receive a ferrule 184a of the plug 12a. The basic housing 60a comprises at least one latching receptacle 90a for receiving a latching element 186a of the plug 12a. The latching receptacle 90a is configured for a latching connection with the latching element 184a of the plug 12a in a state when the plug 12a is connected with the fiber optic adapter 10a. The fiber optic adapter 10a comprises at least one clip-on frame 70a. The clip-on frame 70a is configured to receive the basic housing 60a. The clip-on frame 70a comprises at least one clip 72a, which is configured at least to create a clip connection and/or a screw connection to a patch field and/or a patch panel.

The fiber optic adapter 10a comprises a protection unit 20a, which is arranged at the basic housing 60a. The protection unit 20a comprises at least one fastening element 32a. The fastening element 32a is configured to fasten the protection unit 20a in the basic housing 60a. The fastening element 32a is configured to fasten the protection unit 20a on the base body 72a of the basic housing 60a. The protection unit 20a is also suitable for a fastening to further fiber optic adapters. The protection unit 20a comprises at least one dust protection closure element 24a for a dust-tight closure of the plug connection opening 78a. The at least one further plug connection opening 80a can be closed in a dust-tight manner by means of a further dust protection closure element 26a of the protection unit 20a. The fiber optic adapter 10a comprises a further protection unit 22a, which is arranged on the basic housing 60a. The further protection unit 22a comprises further dust protection closure elements, which in a dust-tight manner close the plug connection openings 82a, 84a, which are situated opposite the plug connection opening 78a and the further plug connection opening 80a.

The protection unit 20a is at least largely spring-elastic. The dust protection closure element 24a is spring-elastic. The further dust protection closure element 24a is spring-elastic. The dust protection closure element 24a is realized so as to be self-resetting into a closure position of the dust protection closure element 24a at the plug connection opening 78a. The further dust protection closure element 24a is realized so as to be self-resetting into a closure position of the dust protection closure element 24a. The pivot axis of the dust protection closure element 24a is on that side of the plug connection opening 78a which forms the partition wall 114a. The pivot axis is situated at least approximately in a main extension plane realized by the partition wall 114a. The further dust protection closure element 26a is identical to the dust protection closure element 24a. The further dust protection closure element 24a realizes all elements of the dust protection closure element 24a. The further plug connection opening 80a and/or the further dust protection closure element 26a are realized mirror-symmetrically to the plug connection opening 78a and/or the dust protection closure element 24a with respect to a mirror plane formed by the main extension plane of the partition wall 114a.

The protection unit 20a is realized as a monolithic component. The protection unit 20a is realized as a bent sheet metal part. The protection unit 20a has a continuous structure, which is realized free of joinings or connections of separate components. The protection unit 20a consists of a monolithic bent sheet metal part. The bent sheet metal part forms the fastening element 32a. The bent sheet metal part forms the dust protection closure element 24a. The bent sheet metal part forms the further dust protection closure element 26a. The spring elasticity of the dust protection closure element 24a and of the further dust protection closure element 26a is provided by the material properties of the monolithic bent sheet metal part. The dust protection closure element 24a is configured to enable an insertion of the plug 12a by the bending of the bent sheet metal part.

The protection unit 20a, as a monolithic component, forms the dust protection closure element 24a and the further dust protection closure element 26a. The protection unit 20a is realized at least approximately in a V-shaped fashion. The dust protection closure element 24a and the further dust protection closure element 24a in each case form an arm of the V-shape. The dust protection closure element 24a and the further dust protection closure element 24a project—convexly towards each other and starting from the partition wall 114a—over the plug connection opening 78a. The dust protection closure element 24a merges into the fastening element 32a, which is folded around a proximal end edge of the partition wall 114a. The partition wall 114a is configured to absorb forces acting onto the dust protection closure element 24a.

The protection unit 20a comprises at least one laser protection element 28a. The laser protection element 28a is realized so as to be spring-elastic and to be self-resetting into a closure position of the laser protection element 28a at the plug connection opening. The laser protection element 28a is configured to prevent an emergence of light beams from the inner region of the basic housing 60a. The laser protection element 28a blocks the light beams from the further plug 12a in the opposite-situated plug connection openings 82a, 84a, which is connected with the fiber optic adapter 10a. The laser protection element 28a is made of a non-transparent material which reflects and/or absorbs light within the basic housing 60a in order to provide laser protection properties.

The laser protection element 28a is realized integrally with the dust protection closure element 24a. The laser protection element 28a is realized in one piece with the dust protection closure element 24a. The laser protection element 28a is realized so as to be component-wise identical to the dust protection closure element 24a. The dust protection closure element 24a and the laser protection element 28a differ only function-wise. The bent sheet metal part forms the laser protection element 28a. The spring elasticity of the laser protection element 28a is provided by the material properties of the monolithic bent sheet metal part. The laser protection element 28a is configured to enable an insertion of the plug 12a by the bending of the bent sheet metal part. The protection unit 20a, as a monolithic component, forms the laser protection element 28a and a further laser protection element 30a. The further laser protection element 30a is realized integrally with the further dust protection closure element 24a.

The further plug connection opening 80a and the further dust protection closure element 26a are realized completely mirror-symmetrically to the plug connection opening 78a and the dust protection closure element 24a. Accordingly, in the following a further description of the further plug connection opening 80a and of the further dust protection closure element 24a is dispensed with, wherein it is also possible to transfer to the same extent any implementation of the plug connection opening 78a and of the dust protection closure element 24a to the further plug connection opening 80a and the further dust protection closure element 26a. To the same extent, the plug connection opening 82a and the further plug connection opening 84a, which are situated opposite the plug connection opening 78a and the further plug connection opening 80a and opposite the protection unit 20a, as well as the further protection unit 22a are also realized completely mirror-symmetrically. Accordingly, in the following a further description of the opposite-situated plug connection opening 82a, of the opposite-situated further plug connection opening 84a and of the further protection unit 22a is dispensed with, wherein it is also possible to transfer any implementation of the plug connection opening 78a, the further plug connection opening 80a and the protection unit 20a to the opposite-situated plug connection opening 82a, the opposite-situated further plug connection opening 84a and the further protection unit 22a.

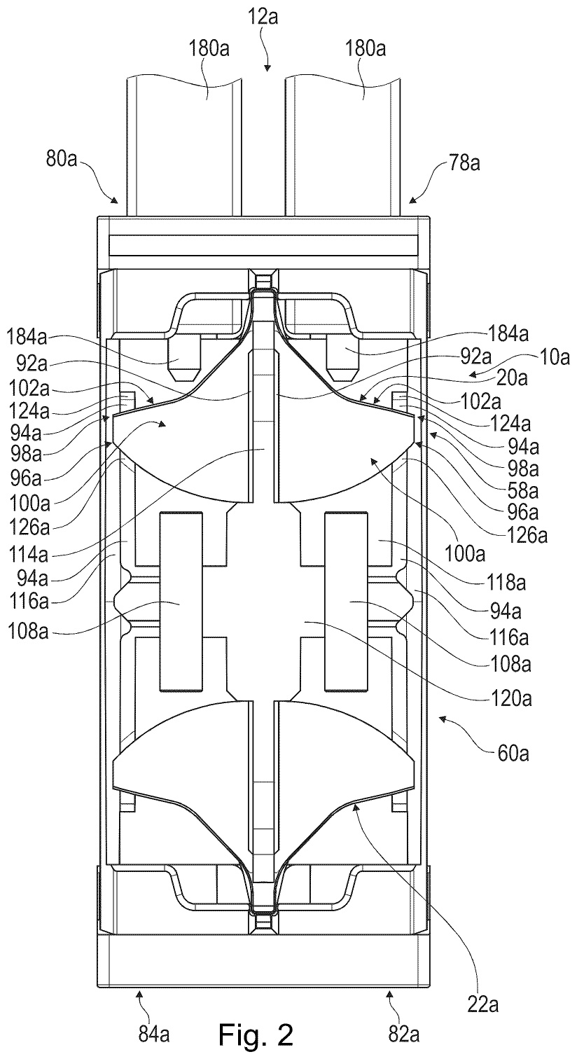

FIG. 2 shows a plan view of the fiber optic adapter 10a, open at the top, with the basic housing 60a, with the protection unit 20a and with the plug 12a, the plug 12a being partially inserted in one of the plug connection openings 78a of the basic housing 60a. The fiber optic adapter 10a comprises a guide unit 58a for guiding the plug 12a during an insertion of the plug 12a into the basic housing 60a. The guide unit 58a comprises at least one horizontal guide element 34a. The horizontal guide element 34a is formed by the dust protection closure element 24a. The guide unit 58a comprises at least one further horizontal guide element 36a formed by the further dust protection closure element 26a. The horizontal guide element 34a and the dust protection closure element 24a and/or the laser protection element 28a are realized identically. The horizontal guide element 34a and the dust protection closure element 24a and/or the laser protection element 28a differ only function-wise. The horizontal guide element 34a is configured, during the insertion of the plug 12a, to bend in a continuous manner. The horizontal guide element 34a is configured to extend along a basic-housing wall.

The basic housing 60a comprises guide elements 92a. The partition wall 114a comprises at least one guide element 92a for the horizontal guide element 34a. The guide element 92a is realized as a bulge. During the insertion of the plug 12a, the horizontal guide element 34a extends over the guide elements 92a. The horizontal guide element 34a is configured to prevent a displacement of the plug 12a perpendicularly to the plug-in axis in the horizontal plane. The horizontal guide element 34a is realized for bending over the guide element 92a during the insertion of the plug 12a, thus providing a guidance of the plug 12a. The horizontal guide element 34a is configured, together with the guide element 92a, to clamp the plug 12a in the horizontal plane during the plug-in process.

The basic housing 60a has a vertical guiding surface 94a. The guide unit 58a comprises the vertical guiding surface 94a. The vertical guiding surface 94a comprises at least one chamfer 124a, 126a arranged on the opening side. The vertical guiding surface 94a is configured to form a support surface for the plug 12a. The vertical guiding surface 94a forms a support surface for the plug 12a along the plug-in path of the plug 12a. The vertical guiding surface 94a is configured for guiding the plug 12a on that side of the basic housing 60a which forms the latching receptacle 90a for the latching element 184a of the plug 12a. The vertical guiding surface 94a is realized differently from a horizontal outer wall 118a of the basic housing 60a. The vertical guiding surface 94a adjoins a vertical outer wall 116a of the basic housing 60a. The vertical guiding surface 94a forms only a support surface for an edge region of the plug 12a.

The vertical guiding surface 94a extends at least approximately over 75% of a plug-in path of the basic housing 60a from the plug entry 86a to the plug abutment 120a. The vertical guiding surface 94a comprises at least one interruption for the pivoting region of the dust protection closure element 24a. Next to the interruption, the vertical guiding surface 94a has a further chamfer 126a, which is arranged on the opening side.

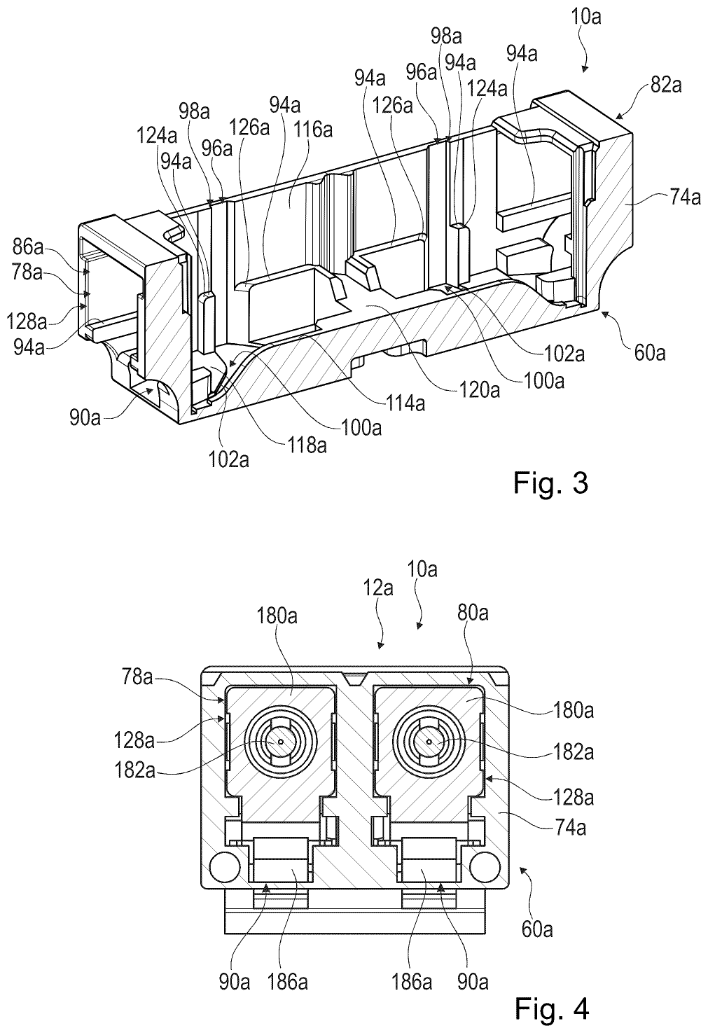

FIG. 3 shows a sectional view of the base body 74a of the basic housing 60a. The basic housing 60a forms a vertical abutment surface 98a for a vertical end region 54a of the dust protection closure element 24a in the closure position. The vertical abutment surface 98a extends over an at least substantially entire vertical extent of the dust protection closure element 24a. The vertical abutment surface 98a is configured to close the inner region with the vertical end region 54a of the dust protection closure element 24a, at least with respect to the vertical outer wall 116a of the basic housing 60a, regarding an entry of dust. The vertical end region 54a is an end region of the dust protection closure element 24a, which has a free end. The vertical abutment surface 98a extends over 98% of the dust protection closure element 24a. The vertical abutment surface 98a extends over an at least substantially entire vertical extent of the inner region of the basic housing 60a. The vertical abutment surface 98a extends over 98% of the vertical extent of the inner region of the basic housing 60a. The vertical abutment surface 98a is configured, in the closure position, to provide a counterforce for the elastic pretensioning of the dust protection closure element 24a. The vertical outer wall 116a of the basic housing 60a at least partially forms the vertical abutment surface 98a. The vertical abutment surface 98a forms at least the interruption of the vertical guiding surface 98a.

In the closure position the basic housing 60a forms at least one horizontal abutment surface 102a for a horizontal end region 56a of the dust protection closure element 24a. The horizontal abutment surface 102a is configured to close the inner region with the horizontal end region 56a, at least with respect to the horizontal outer wall 118a of the basic housing 60a, regarding the entry of dust. The horizontal end region 56a of the dust protection closure element 24a is a lateral region of the dust protection closure element 24a, which is different from the end region comprising the free end of the dust protection closure element 24a. At least one of the horizontal outer walls 118a of the basic housing 60a comprises the horizontal abutment surface 102a. The horizontal outer wall 118a on the side of the latching receptacle 90a of the basic housing 60a comprises the horizontal abutment surface 102a. The horizontal abutment surface 102a extends at least substantially over an entire horizontal extent of the dust protection closure element 24a. The horizontal abutment surface 102a extends over at least 98% of the horizontal extent of the dust protection closure element 24a. The horizontal abutment surface 102a extends at least substantially over an entire horizontal extent of the inner region of the basic housing 60a. The horizontal abutment surface 102a extends over at least 98% of the horizontal extent of the inner region of the basic housing 60a.

The vertical abutment surface 98a is configured, together with horizontal abutment surfaces 102a, to create an at least largely circumferential sealing in the closure position of the dust protection closure element 24a. The plug connection opening 78a is sealed on the side of the partition wall 114a by the fastening element 32a of the protection unit 20a. The plug connection opening 78a is sealed on the side of the partition wall 114a by the bending of the fastening region around the end region of the partition wall 114a. The plug connection opening 78a is sealed in a dust-tight manner on the two vertical sides of the plug connection opening 78a and on at least one horizontal side of the plug connection opening 78a at least by the overlapping or by the bending. An edge of a further horizontal end region 57a of the dust protection closure element 24a, which is arranged opposite the horizontal region, is arranged so as to bear against a further horizontal outer wall 117a which is arranged opposite the horizontal outer wall 118a of the basic housing 60a. During the pivoting movement, the edge of the further horizontal end region 57a glides on the further horizontal outer wall 117a of the basic housing 60a.

In the closure position the dust protection closure element 24a is elastically pretensioned. In the closure position the laser protection element 28a is elastically pretensioned. In the closure position the dust protection closure element 24a continuously exerts force onto one of the abutment surfaces 98a, 102a of the basic housing 60a. The dust protection closure element 24a is elastically pretensioned against the vertical abutment surface 98a. The dust protection closure element 24a is elastically pretensioned against the horizontal abutment surface 102a. The closure position of the dust protection closure element 24a is defined by the vertical abutment surface 98a, from which the dust protection closure element 24a is realized so as to be spring-elastically self-resetting upon insertion of the plug 12a into the plug connection opening 78a. The closure position of the dust protection closure element 24a is defined by the horizontal abutment surface 102a, from which the dust protection closure element 24a is realized so as to be spring-elastically self-resetting upon insertion of a plug 12a into the plug connection opening 78a.

The basic housing 60a forms at least one depression 100a, which creates the at least one horizontal abutment surface 102a. The depression 100a is realized as a section-wise thinning of the horizontal outer wall 118a of the basic housing 60a. An edge of the depression 100a forms the horizontal abutment surface 102a. The depression 100a for the horizontal abutment surface 102a extends over the entire pivoting region of the dust protection closure element 24a. The horizontal end region 56a of the dust protection closure element 24a is arranged in the depression 100a over the entire pivoting region from the closure position to the opening position of the dust protection closure element 24a. The depression 100a for the horizontal abutment surface 102a is realized at least approximately in the shape of a half gingko leaf. The depression 100a of the horizontal abutment surface 102a of the dust protection closure element 24a and a further depression 100a of a further horizontal abutment surface 102a of the further dust protection closure element 24a are realized together so as to be at least approximately in the shape of a gingko leaf.

The basic housing 60a forms at least one depression 96a, which creates the vertical abutment surface 98a. The depression 96a is realized as a section-wise thinning of the vertical outer wall 116a of the basic housing 60a. An edge of the depression 96a forms the vertical abutment surface 98a. During the pivoting movement, the vertical end region 54a of the dust protection closure element 24a is arranged—at least starting from the closure position—section-wise in the depression 96a. The vertical end region 54a is configured to pivot out of the depression 96a during the pivoting movement. The depression 96a, which forms the vertical abutment surface 98a, implements the interruption of the vertical guiding surface 94a.

FIG. 4 shows a sectional view of the fiber optic adapter 10a and of the plug 12a, with the plug 12a being arranged completely in the plug connection opening 78a. The basic housing 60a has a base frame 128a. Viewed in the plug-in direction, the base frame 128a of the basic housing 60a delimits the plug connection opening 78a from four sides. The basic housing 60a is realized such that the base frame 128a is arranged at the plug entry 86a of the basic housing 60a which, viewed in the plug-in direction, delimits the plug 12a from four sides. The base frame 128a supports the plug 12a in the plug entry 86a in all directions perpendicular to the plug-in axis. During the entire plug-in process and in a completely connected state, the base frame 128a is on all four sides in direct contact with the plug 12a at least in a subregion of each side of a plug body 180a of the plug 12a. The base frame 128a extends at least over a subregion of the plug connection opening 78a. The base frame 128a extends over at least 20% of the plug connection opening 78a from the plug entry 86a to the plug abutment 120a.

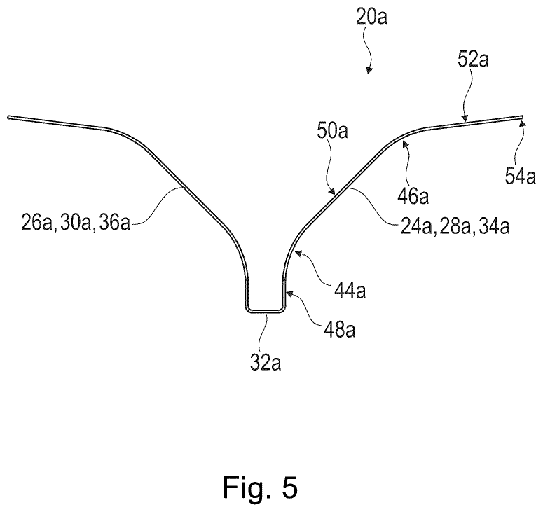

FIG. 5 shows the protection unit 20a, at least with the dust protection closure element 24a, the laser protection element 28a and the fastening element 32a. The dust protection closure element 24a has a shape which enables—with respect to a ferrule 184a of the plug 12a and to the dust protection closure element 24a—a contact-free insertion of the plug 12a into the basic housing 60a. Viewed along the horizontal extent of the dust protection closure element 24a, the dust protection closure element 24a has at least one curved part 44a, 46a. Viewed along the horizontal extent of the dust protection closure element 24a, the dust protection closure element 24a has at least two curved parts 44a, 46a. Viewed along the horizontal extent of the dust protection closure element 24a, the dust protection closure element 24a has at least one linear part 48a, 50a, 52a. Viewed along the horizontal extent of the dust protection closure element 24a, the dust protection closure element 24a has at least three linear parts 48a, 50a, 52a. Starting from the partition wall 114a of the basic housing 60a, the first linear part 48a of the dust protection closure element 24a is realized so as to bear against the partition wall 114a. Starting from the partition wall 114a of the basic housing 60a, the first curved part 44a of the dust protection closure element 24a is realized at least substantially so as to begin at the partition wall 114a. Starting from the partition wall 114a of the basic housing 60a, the second curved part 46a of the dust protection closure element 24a is situated at least approximately in a middle region of the plug connection opening 78a.

The at least one curved part 44a, 46a of the dust protection closure element 24a is configured, during a plug-in process, to provide a bending-open of the dust protection closure element 24a. If the plug 12a is arranged completely in the plug connection opening 78a, the at least one curved part 44a, 46a of the dust protection closure element 24a is at least approximately linear. If the plug 12a is arranged completely in the plug connection opening 78a, the dust protection closure element 24a is at least approximately linear. In the closure position of the dust protection closure element 24a, a central angle of the first curved part 44a of the dust protection closure element 24a, starting from a curved-part tangent that is at least approximately parallel to the plug-in axis, is at least approximately 45°. A central angle of the second curved part 46a of the dust protection closure element 24a is between 40° and 35°. The at least one curved part 44a, 46a and the at least one linear part 48a, 50a, 52a of the dust protection closure element 24a are configured for the insertion of the plug 12a that is contact-free with respect to the ferrule 184a. During the plug-in process, the dust protection closure element 24a is in contact only with an edge of the plug body 180a of the plug 12a. The horizontal guide element 34a guides the plug 12a in the horizontal plane only via the edge of the plug body 180a.

During the plug-in process, the plug 12a is guided into the plug connection opening 78a. During the plug-in process, the dust protection closure element 24a is bent open. During the plug-in process, the dust protection closure element 24a is bent at least approximately linearly against the partition wall 114a of the basic housing 60a. During the plug-in process, the dust protection closure element 24a, in particular the horizontal guide element 34a, extends over the guide element 92a of the basic housing 60a and a horizontal guidance is provided. During the plug-in process, the vertical end region 54a of the dust protection closure element 24a is guided out of the depression 96a that forms the vertical abutment surface 98a. During the plug-in process, the horizontal end region 56a of the dust protection closure element 24a is guided in the depression 100a of the horizontal abutment surface 102a. During the plug-in process, the plug 12a is guided over the vertical guiding surface 94a as a support surface.

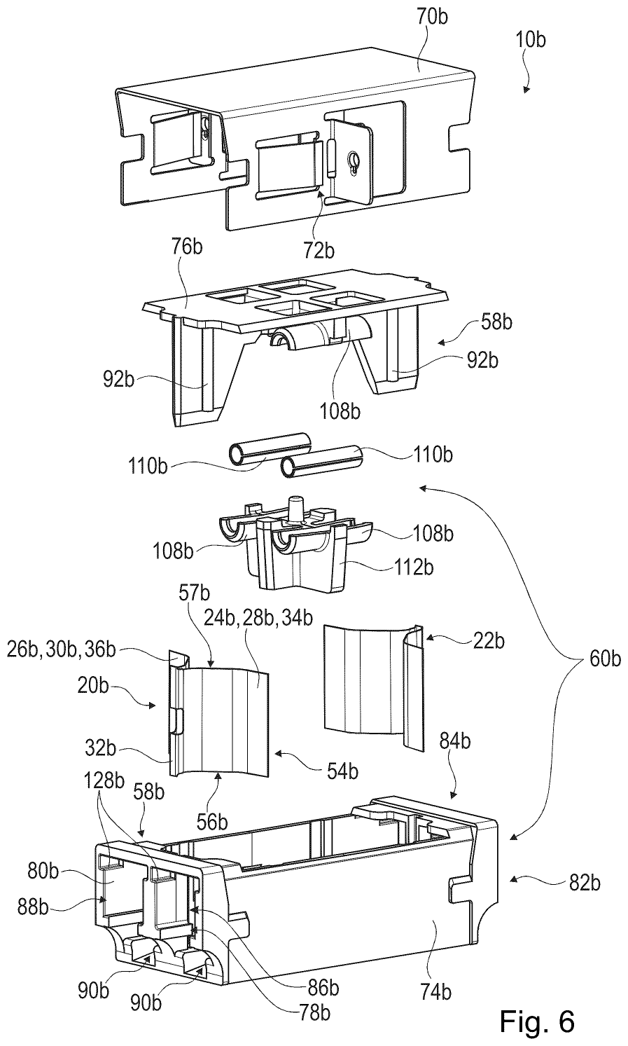

Five further exemplary embodiments of the invention are shown in FIGS. 6 to 12. The following descriptions and the drawings are substantially restricted to the differences between the exemplary embodiments, wherein with respect to components having the same denomination, in particular with respect to components having the same reference numerals, in principle reference can also be made to the drawings and/or the description of the other exemplary embodiments, in particular of FIGS. 1 to 5. In order to distinguish between the exemplary embodiments, the letter a has been added to the reference numerals of the exemplary embodiment in FIGS. 1 to 5. In the exemplary embodiments of FIGS. 6 to 14, the letter a has been replaced by the letters b to f.

FIG. 6 shows an exploded illustration of an alternative fiber optic adapter 10b, with a basic housing 60b and with at least one protection unit 20b, the fiber optic adapter 10b being realized in such a way that it can be assembled on one side. The fiber optic adapter 10b can be assembled on one side in a plane perpendicular to a plug-in axis of a plug 12b. A plug connection opening 78b of the basic housing 60b is at least substantially completely freely accessible for the mounting. The plug connection opening 78b is completely freely accessible with the exception of a base frame 128a of the basic housing 60b. The basic housing 60b has at least one base body 74b. The base body 74b provides a one-sided assembly of the fiber optic adapter 10b.

The base body 74b is realized so as to provide vertical insertion of all elements of the fiber optic adapter 10b. The base body 74b is realized so as to provide vertical insertion of the protection unit 20b. Following the vertical insertion of the protection unit 20b, a fastening element 32b of the protection unit 20b is laid around a proximal end of a partition wall 114b of the fiber optic adapter 10b. Following the vertical insertion of the protection unit 20b, a dust protection closure element 24b has been laid over the plug connection opening in a closure position.

A conductor guide 108b of the basic housing 60b, which is configured to receive a ferrule 184b of the plug 12b, is realized in a two-part implementation. The conductor guide 108b is divided in a horizontal middle plane. The basic housing 60b comprises at least one conductor guide housing 112b. The conductor guide housing 112b provides—with respect to the insertion axis—vertical insertion of conductor guide sleeves 110b into the conductor guide 108b. The conductor guide housing 112b provides a plug abutment 120b of the plug connection opening 78b. The conductor guide housing 112b is configured for a vertical insertion into the base body 74b. The conductor guide sleeves 110b are configured for a vertical insertion into the conductor guide housing 112b. The basic housing 60b comprises a cover 76b. The cover 76b forms at least a second half of the conductor guide 108b. The cover 76b is configured for a vertical insertion into the base body 74b. When the cover 76b has been placed on the basic housing 60b, the conductor guide sleeve 110b is encompassed by the conductor guide 108b of the conductor guide housing 112b and the conductor guide 108b of the cover 76b.

The fiber optic adapter 10b comprises at least one clip-on frame 70b. The clip-on frame 70b is configured to be guided vertically onto the basic housing 60b. The basic housing 60b comprises a receptacle for the clip-on frame 70b, which provides the vertical guidance of the clip-on frame 70b.

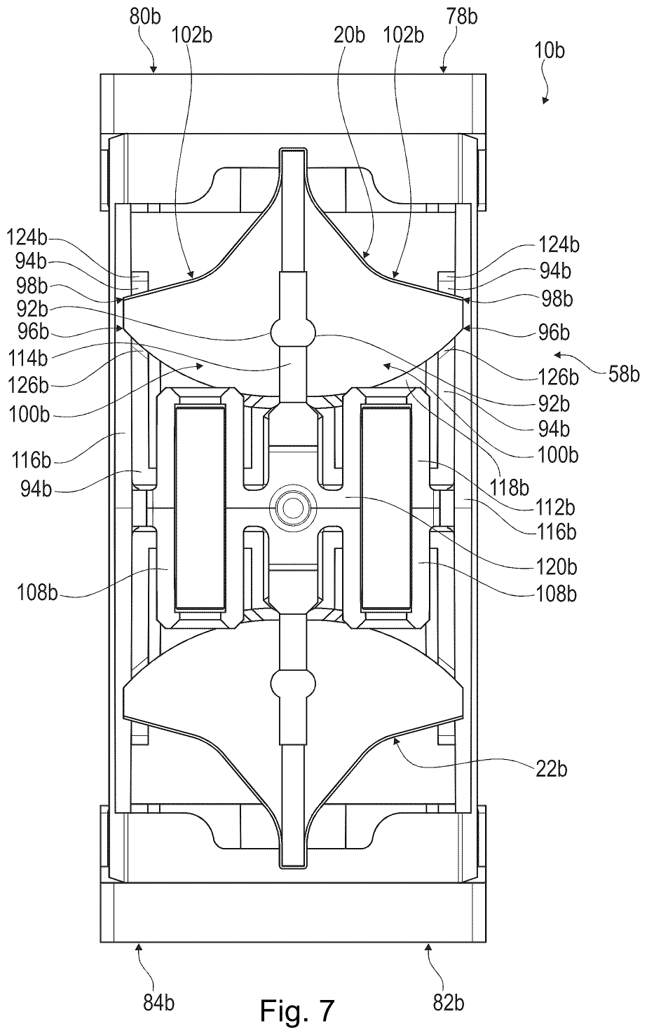

FIG. 7 shows a sectional view of the alternative fiber optic adapter 10b, with the basic housing 60b and with the protection unit 20b mounted therein. The cover 76b comprises at least one guide element 92b. The guide elements 92b are realized as curves. A horizontal guide element 34b of the protection unit 20b is configured, during a plug-in process, to provide a horizontal guidance of the plug 12b. The horizontal guide element 34b is configured, during a plug-in process, to provide the horizontal guidance by being bent over the guide elements 92b which are realized as curves.

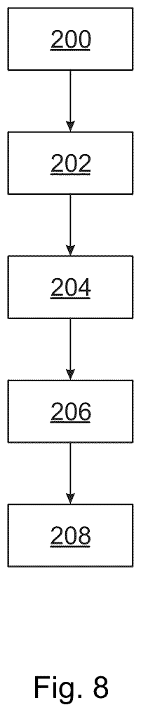

FIG. 8 shows a method for manufacturing a fiber optic adapter 10b. The fiber optic adapter 10b is assembled on one side. All individual parts of the fiber optic adapter 10b are mounted vertically one by one. All individual parts of the fiber optic adapter 10b are inserted into the base body 74b of the basic housing 60b. In at least one first method step 200b, the dust protection closure element 24b is guided into the base body 74b of the basic housing 60b. The fastening element 32b of the protection unit 20b is guided by the vertical insertion around the proximal end of a partition wall 114b of the basic housing 60b. The dust protection closure element 24b is laid over the plug connection opening 78b in the closure position. In at least one further method step 202b, the conductor guide housing 112b is guided vertically into the base body 74b of the basic housing 60b. In at least one further method step 204b, the conductor guide sleeve 110b is laid vertically into the half of the conductor guide 108b of the conductor guide housing 112b. In at least one further method step 206b, the cover 76b of the basic housing 60b is mounted on the base body 74b of the basic housing 60b for closing the basic housing 60b. In the method step 206b, the conductor guide 108b for the conductor guide sleeve 110b is closed by the cover 76b. In at least one further method step 208b, the clip-on frame 70b is guided onto the basic housing 60b via the cover 76b.

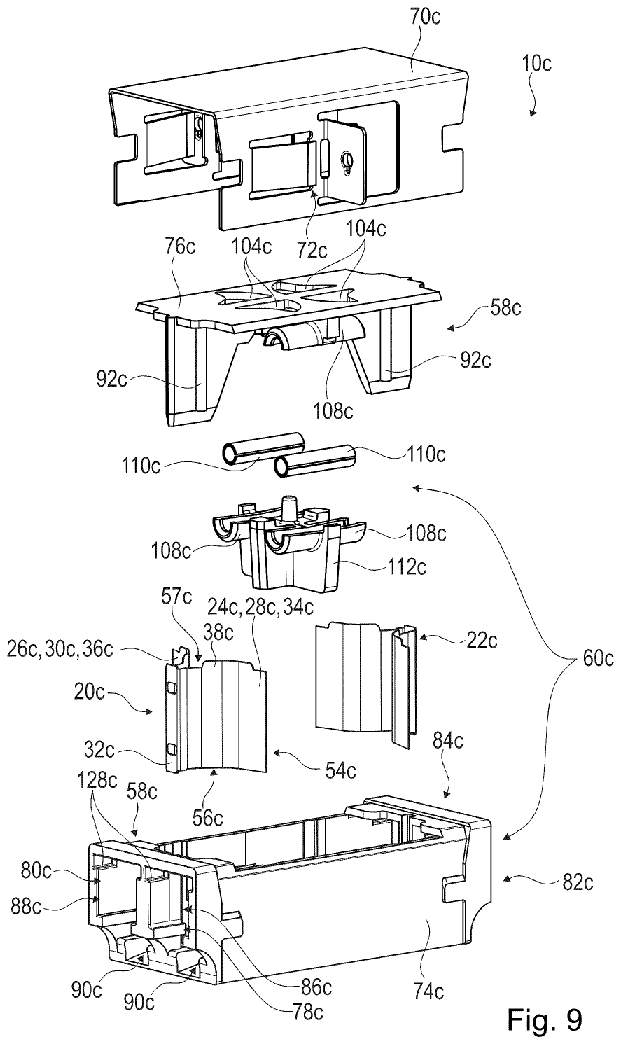

FIG. 9 shows an exploded illustration of a further alternative fiber optic adapter 10c, with a basic housing 60c and with at least one protection unit 20c, the basic housing 60c comprising recesses 104c at least for a part of the protection unit 20c. The basic housing 60c forms at least one recess 104c, which creates at least one horizontal abutment surface 106c. The basic housing 60c comprises two horizontal outer walls, wherein both horizontal outer walls of the basic housing 60c in each case have a horizontal abutment surface. The further horizontal abutment surface 106c is realized as a recess 104c. The recess 104c is realized in the horizontal outer wall 117c of the basic housing 60c, on a side opposite a side of a latching receptacle 90c. A cover 76c of the basic housing 60c comprises the recess 104c. An edge formed by the recess 104c implements the further horizontal abutment surface 106c.

The protection unit 20c comprises at least one dust protection closure element 24c. The dust protection closure element 24c is configured for a dust-tight closure of a plug connection opening 78c of the basic housing 60c at least by means of a sealing with at least one abutment surface. The dust protection closure element 24c comprises an abutment portion 38c. The abutment portion 38c is configured for an abutment with the horizontal abutment surface 106c formed by the recess 104c. The abutment portion 38c is realized within the basic housing 60c, starting from a horizontal edge of the dust protection closure element 24c, as a bulge. The abutment portion 38c is arranged in a further horizontal end region 57c of the dust protection closure element 24c.

The fiber optic adapter 10c comprises a clip-on frame 70c. The clip-on frame 70c is configured at least for closing the recess 104c of the basic housing 60c in a dust-tight manner.

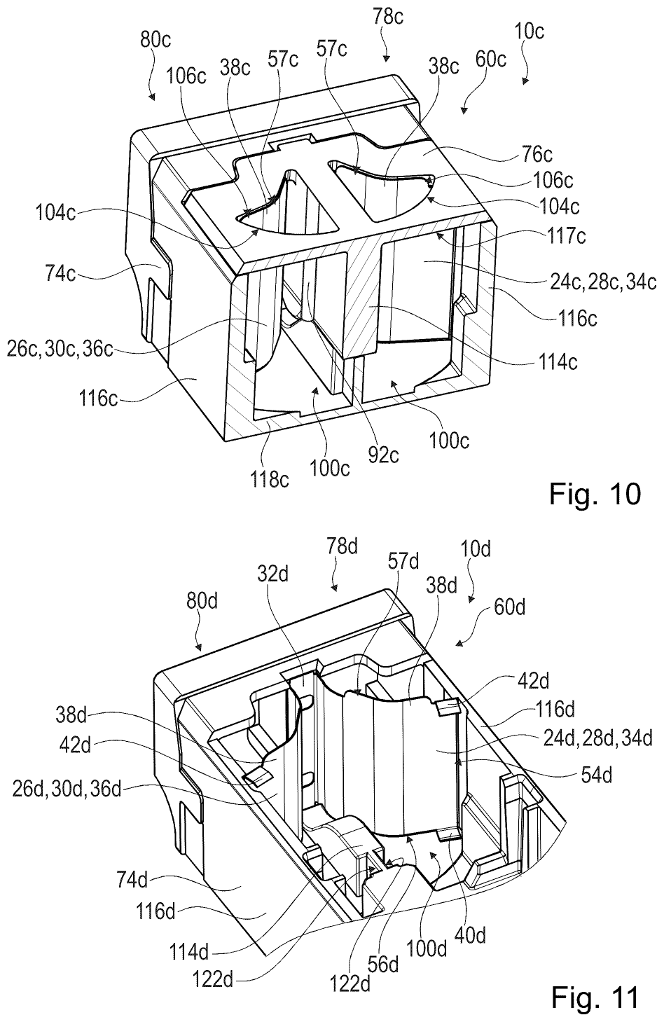

FIG. 10 shows a sectional view of the further alternative fiber optic adapter 10c, with the basic housing 60c and with the protection unit 20c mounted therein. The abutment portion 38c of the dust protection closure element 24c of the protection unit 20c is arranged in the recess 104c. The abutment portion 38c extends beyond the inner region of the basic housing 60c. The abutment portion 38c of the dust protection closure element 24c is arranged in the recess 104c over an entire pivoting region of the dust protection closure element 24c from the closure position to an opening position. The dust protection closure element 24c is at least partly elastically pretensioned with respect to the horizontal abutment surface 106c formed by the recess 104c.

The basic housing 60c has a vertical abutment surface 96c for an abutment of a vertical end region 94c of the dust protection closure element 24c in the closure position. The vertical abutment surface 96c is configured, together with the horizontal abutment surfaces 102c, 108c, to create an at least largely circumferential sealing in the closure position of the dust protection closure element 24c. On at least three sides of the plug connection opening 78c, the basic housing 60c has a vertical abutment surface 96c or a horizontal abutment surface 102c, 108c, which—at least by means of an overlap—closes the plug connection opening 78c in a dust-tight manner. The plug connection opening 78c is sealed on the side of the partition wall 114c by the fastening element 32c of the protection unit 20c. The plug connection opening 78c is sealed on the side of the partition wall 114c by the fastening region being bent around the proximal end region of the partition wall 114c. The dust protection closure element 24c is sealed on all four sides of the plug connection opening 78c by an abutment surface or by a fastening.

FIG. 11 shows a sectional view of a further alternative fiber optic adapter 10d, with a portion of a basic housing 60d and with a protection unit 20d, the protection unit 20d comprising at least one glide shoe 40d. The protection unit 20d comprises at least one dust protection closure element 24d. The dust protection closure element 24d comprises at least the glide shoe 40d. The glide shoe 40d is configured for a low-friction interaction between the dust protection closure element 24d that is realized as a bent sheet metal part and a horizontal outer wall 116d of an inner region of the basic housing 60d. The glide shoe 40d is formed from a bent sheet metal part of the dust protection closure element 24d. The glide shoe 40d is arranged at a horizontal end region 56d of the dust protection closure element 24d. The glide shoe 40d is arranged in the direction of the inner region, opposite the horizontal abutment surface 102d, at the horizontal end region 56d of the dust protection closure element 24d. The glide shoe 40d is configured to glide in a depression 100d of the horizontal abutment surface 102d. The glide shoe 40d is arranged at least approximately at a vertical end region 54d of the dust protection closure element 24d. The glide shoe 40d is an inwards-angled sheet metal part of the dust protection closure element 24d, wherein a surface of the glide shoe 40d that is different from an edge is configured for the gliding.

The dust protection closure element 24d comprises at least one further glide shoe 42d. The further glide shoe 42d is configured for a low-friction interaction between the dust protection closure element 24d that is realized as a bent sheet metal part and a horizontal outer wall 117d of the basic housing 60d that is situated opposite the horizontal outer wall 116d. The further glide shoe 42d is arranged on a side of the dust protection closure element 24d which comprises an abutment portion. The further glide shoe 42d is arranged at least approximately at a vertical end region 54d of the dust protection closure element 24d. The further glide shoe 42d is realized as an inwards-angled sheet metal part of the dust protection closure element 24d, wherein a surface of the further glide shoe 42d that is different from an edge is configured for the gliding.

The basic housing 60d comprises at least one glide shoe receptacle 122d for receiving the glide shoe 40d in an opening position of the dust protection closure element 24d. A partition wall 114d of the basic housing 60d comprises the glide shoe receptacle 122d for receiving the glide shoe 40d in the opening position of the dust protection closure element 24d. The glide shoe receptacle 122d for receiving the glide shoe 40d is configured to provide an at least approximately linear bearing of the dust protection closure element 24d against the partition wall 114d. The glide shoe receptacle 122d is realized as a recess in the partition wall 114d. The partition wall 114 of the basic housing 60d comprises a further glide shoe receptacle 122d for receiving the further glide shoe 42d in the opening position of the dust protection closure element 24d. The further glide shoe receptacle 122d is realized as a recess in the partition wall 114d. The glide shoe receptacle 122d for receiving the glide shoe 40d and the further glide shoe receptacle 122d for receiving the further glide shoe 42d are realized in a one-part implementation. The recess of the partition wall 114d forms the glide shoe receptacle 122d and the further glide shoe receptacle 122d and extends at least substantially over the entire vertical extent of the partition wall 114d.

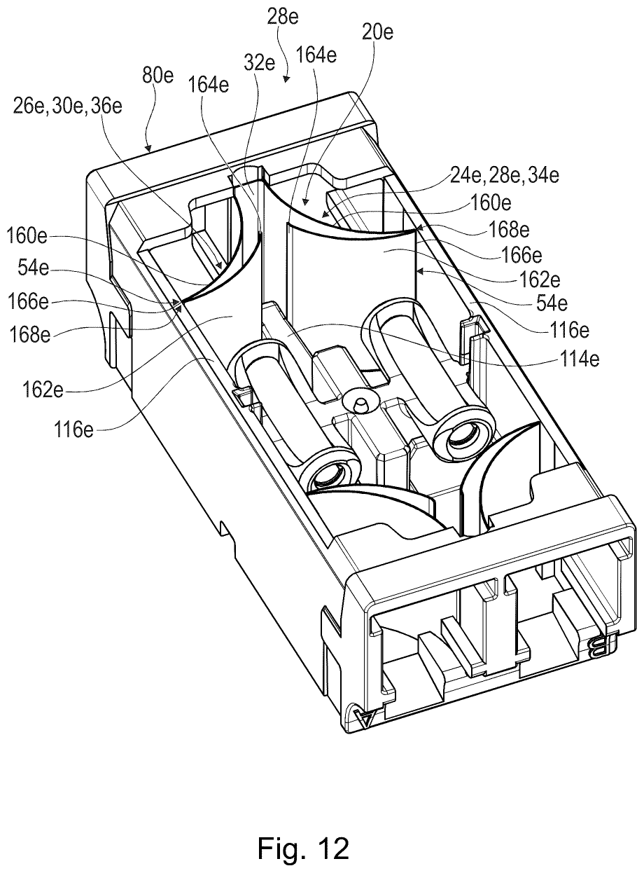

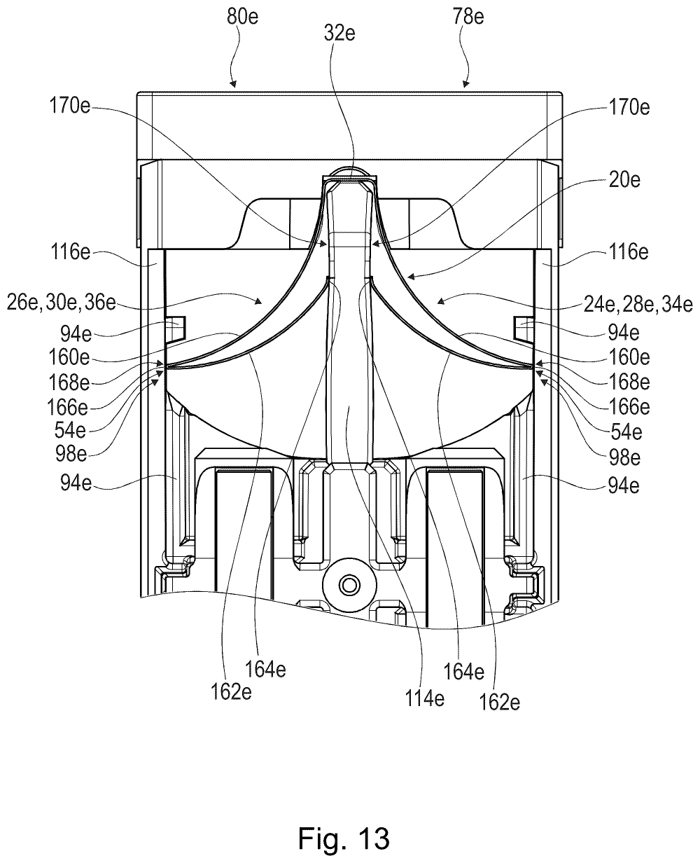

FIGS. 12 and 13 show a further alternative implementation of a fiber optic adapter 10e. The fiber optic adapter 10e comprises a protection unit 20e. The protection unit 20e comprises at least one dust protection closure element 24e, 26e. The dust protection closure element 24e, 26e comprises at least two dust protection closure parts 160e, 162e. The dust protection closure parts 160e, 162e extend completely over a plug connection opening 78e, 80e of the fiber optic adapter 10e. The dust protection closure element 24e, 26e is realized with the two dust protection closure parts 160e, 162e. in a double-walled implementation. Upon insertion of a plug 12e into the plug connection opening 78e, 80e, the two dust protection closure parts 160e, 162e of the dust protection closure element 24e, 26e are realized so as to be pivotable along a vertical axis. Upon insertion of the plug 12e, the dust protection closure parts 160e, 162e are realized so as to extend along a partition wall 114e of a basic housing 60e of the fiber optic adapter 10e. The entry-side dust protection closure part 160e is realized in an arc-shaped implementation. The inner-side dust protection closure part 162e is realized in an arc-shaped implementation. The inner-side dust protection closure part 162e faces towards a plug abutment 120e of the plug connection opening 78e, 80e. The entry-side dust protection closure part 160e has an at least substantially constant curvature radius. The inner-side dust protection closure part 162e has an at least substantially constant curvature radius. The dust protection closure parts 160e, 162e of the dust protection closure element 24e, 26e are curved in the same direction.

The dust protection closure element 24e, 26e comprises a U-bend 166e. The U-bend 166e connects the two dust protection closure elements 24e, 26e and the dust protection closure parts 160e, 162e. The U-bend 166e is configured to provide an abutment 168e with a vertical outer wall 116e of the basic housing 60e. The dust protection closure parts 160e, 162e are realized so as to diverge starting from the U-bend 166e. The entry-side dust protection closure part 160e is connected to a fastening element 32e of the protection unit 20e.

The inner-side dust protection closure part 162e comprises a gliding portion 164e. The gliding portion 164e bears against the partition wall 114e. The gliding portion 164e is realized so as to be guidable on the partition wall 114e when the dust protection closure element 24e, 26e is opened. In order to provide an abutment pressure when the dust protection closure element 24e, 26e of the U-bend 166e abuts against the vertical outer wall 116e, the inner-side dust protection closure part 162e is pretensioned between the partition wall 114e and the vertical outer wall 116e. The arc shape of the inner-side dust protection closure part 162e provides the pretensioning. The gliding portion 164e bears against the partition wall 114e for the pretensioning. The partition wall 114e of the basic housing 60e comprises a guiding surface 170e, along which the gliding portion 164e of the dust protection closure element 24e, 26e glides. The partition wall 114e is realized so as to be at least partially convex, in particular tapering, in a region of the guiding surface 170e.

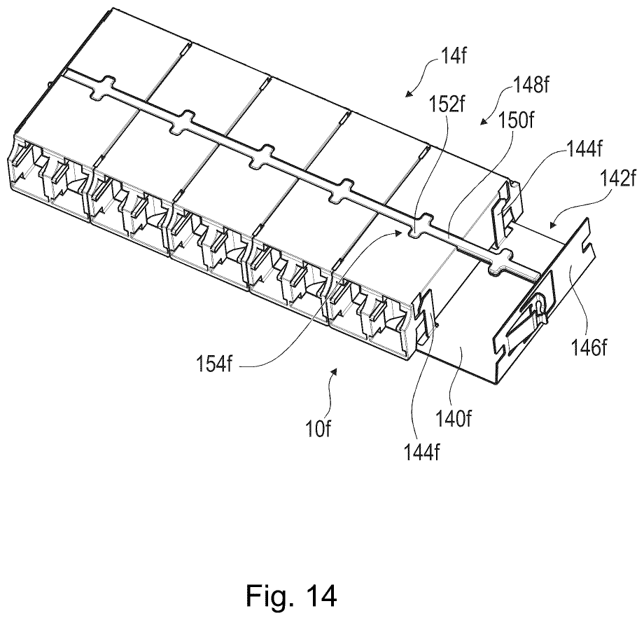

FIG. 14 shows a system 14f with a plurality of fiber optic adapters 10f. The system 14f is designed for six fiber optic adapters 10f. However, a design for a different number of fiber optic adapters 10f, in particular with only two fiber optic adapters 10f, is also conceivable. The system 14f comprises a coupling unit 148f. The coupling unit 148f is configured to connect the fiber optic adapters 10f to one another. The coupling unit 148f is configured to connect the fiber optic adapters 10f to one another in a row. The system 14f comprises a clip-on frame 140f. The clip-on frame 140f at least partially forms the coupling unit 148f. The clip-on frame 140f comprises at least one receptacle 142f for a fixing of the fiber optic adapter 10f. The clip-on frame 140f comprises six receptacles 142f. The clip-on frame 140f comprises intermediate frame elements 144f. The receptacles 142f for the fiber optic adapters 10f are separated from one another by the intermediate frame elements 144f. The intermediate frame elements 144f support the fiber optic adapter 10f in a longitudinal direction of the fiber optic adapter 10f. The intermediate frame elements 144f support the fiber optic adapter 10f in the clip-on frame 140f in the direction of the plug-in path of a fiber optic plug connector. The clip-on frame 140f engages around all fiber optic adapters 10f. The clip-on frame 140f comprises the fiber optic adapters 10f in such a way that two side surfaces 146f of the clip-on frame 140f, which are in each case in contact with one of the fiber optic adapters 10f, are parallel to each other. During assembly, the fiber optic adapter 10f is guided linearly into the clip-on frame 140f.

The coupling unit 148f comprises a coupling element 150f. The coupling element 150f connects the fiber optic adapters 10f. The coupling element 150f connects the fiber optic adapters 10f by a form fit. The fiber optic adapters 10f have at least one recess 154f for a form-fit engagement of the coupling element 150f. The coupling element 150f extends in a form-fit engagement transversely to the fiber optic adapters 10f. The coupling element 150f extends perpendicularly to the plug-in direction of the fiber optic plug connector. The coupling element 150f is realized at least substantially in a rod shape. The coupling element 150f is realized at least approximately in a bone shape. The coupling element 150f has side edges which extend longitudinally and are at least substantially parallel at least section-wise. The coupling element 150f comprises at least one transverse beam 152f. The transverse beam 152f extends perpendicularly to a longitudinal axis of the coupling element 150f. The coupling element 150f comprises a transverse beam 152f for each fiber optic adapter 10f. During assembly, the coupling element 150f is guided linearly onto the fiber optic adapters 10f, and into the recess 154f.

1. A fiber optic adapter with at least one basic housing that comprises at least one plug connection opening for an insertion of a plug into the basic housing, and with a protection unit that is arranged on the basic housing and comprises at least one dust protection closure element for a dust-tight closure of the plug connection opening, wherein the dust protection closure element is realized so as to be spring-elastic and to be self-resetting into a closure position of the dust protection closure element at the plug connection opening.

2. The fiber optic adapter according to claim 1, wherein the protection unit comprises at least one laser protection element, wherein the laser protection element is realized integrally with the dust protection closure element.

3. The fiber optic adapter according to claim 1, wherein the dust protection closure element is elastically pretensioned in the closure position.

4. The fiber optic adapter according to claim 1, wherein the protection unit is realized as a monolithic component, in particular as a bent sheet metal part.

5. The fiber optic adapter according to claim 1, further comprising a guide unit for guiding the plug during an insertion of the plug into the basic housing, with at least one horizontal guide element formed by the dust protection closure element.

6. The fiber optic adapter according to claim 1, wherein the basic housing comprises at least one further plug connection opening, wherein the further plug connection opening can be closed in a dust-tight manner by means of a further dust protection closure element of the protection unit.

7. The fiber optic adapter according to claim 1, wherein the dust protection closure element has a shape which enables an insertion of the plug into the basic housing which is contact-free with respect to a ferrule of the plug and to the dust protection closure element.

8. The fiber optic adapter according to claim 1, further comprising a guide unit for guiding the plug during an insertion of the plug to the basic housing, wherein the basic housing comprises a vertical guiding surface having at least one chamfer arranged on the opening side.

9. The fiber optic adapter according to claim 1, wherein viewed in the plug-in direction, a base frame of the basic housing delimits the plug connection opening from four sides.

10. The fiber optic adapter according to claim 1, wherein the basic housing forms a vertical abutment surface for a vertical end region of the dust protection closure element in the closure position, said vertical abutment surface in particular extending over an at least substantially entire vertical extent of the dust protection closure element.

11. The fiber optic adapter according to claim 1, wherein the basic housing forms at least one horizontal abutment surface for a horizontal end region of the dust protection closure element in the closure position.

12. The fiber optic adapter according to claims 11, wherein the basic housing forms a vertical abutment surface for a vertical end region of the dust protection closure element in the closure position, said vertical abutment surface in particular extending over an at least substantially entire vertical extent of the dust protection closure element, wherein the vertical abutment surface is configured, together with horizontal abutment surfaces, to create an at least largely circumferential sealing in the closure position of the dust protection closure element.

13. The fiber optic adapter according to claim 1, wherein the basic housing forms at least one recess or depression, which creates at least one horizontal abutment surface for a horizontal end region of the dust protection closure element in the closure position and/or the vertical abutment surface for a vertical end region of the dust protection closure element in the closure position.

14. The fiber optic adapter according to claim 1, wherein the dust protection closure element comprises at least one glide shoe.

15. A protection unit for a fiber optic adapter according to claim 1.

16. A method for manufacturing a fiber optic adapter according to claim 1, wherein the fiber optic adapter is assembled on one side.
